(19) United States
(12) Patent Application Publication
(10) Pub. No.: US 2007/0058292 A1
(43) Pub. Date: Mar. 15, 2007

(54) SPINDLE MOTOR ASSEMBLY USEABLE IN A HARD DISK DRIVE

(76) Inventors: Sung-kwon Choi, Seoul (KR); Haeng-soo Lee, Suwon-si (KR); Yusuke Kanayama, Yokohama-si (JP); Takahiro Tokumiya, Yokohama-si (JP)

Correspondence Address: STANZIONE & KIM, LLP, 919 18TH STREET, N.W., SUITE 440, WASHINGTON, DC, 20006, US

(21) Appl. No.: 11/530,526

(22) Filed: Sep. 11, 2006

(30) Foreign Application Priority Data
Sep. 9, 2005 (KR) 2005-84253

(51) Int. Cl. G11B 17/02

(52) U.S. Cl. 360/99.12

(57) ABSTRACT

A spindle motor assembly usable with a hard disk drive includes at least one data storage disk, a spindle motor to drive the disk, the spindle motor having a hub on which the data storage disk is fixed, and a clamp member to fix the data storage disk to the hub by pressing the data storage disk axially toward the hub. When the clamp member presses a first location of the data storage disk and the hub has a supporting center corresponding to a second location of the data storage disk, the first location is closer to a center of the data storage than the second location.

### CROSS-REFERENCE TO RELATED APPLICATIONS

This application claims priority under 35 U.S.C. §119 (a) Korean Patent Application No. 10-2005-0084253, filed on Sep. 9, 2005, in the Korean Intellectual Property Office, the disclosure of which is incorporated herein in its entirety by reference.

### BACKGROUND OF THE INVENTION

1. Field of the Invention

The present general inventive concept relates to a spindle motor assembly that can be applied to a hard disk drive, and more particularly, to a spindle motor assembly that can prevent flexing of a disk and increase storage capacity.

2. Description of the Related Art

A hard disk drive (HDD) and an optical disk drive (ODD) are data storage devices that read and write data from and to a disk rotatably mounted on a spindle motor.

FIG. 1 is a sectional view illustrating a conventional spindle motor assembly. Referring to FIG. 1, the conventional spindle motor assembly includes an information storage disk 140 and a spindle motor 130 for supporting and rotating the information storage disk 140. The spindle motor 130 includes a shaft 131 rotatably installed on a base frame 110, a stator 133 fixed around the shaft 131, and a rotor such as a hub 135 surrounding the stator 133. The hub 135 includes an upper end 135a having a center hole through which a screw member 160 is inserted, a sidewall portion 135b extending from the upper end 135a, and a flange portion 135c extending radially from the sidewall portion 135b. The information storage disk 140 is fitted to the sidewall portion 135b and placed on the flange portion 135c. The flange portion 135c provides a supporting plane delimited by an inner radius R′i and an outer radius R′o.

A clamp member 150 is located above the hub 135 to press the disk 140 onto the hub 135. The clamp member 150 has an inner edge fixed by the screw member 160 and an outer edge extending toward the data storage disk 140. A pressure portion 151 is formed on the outer edge. The pressure portion 151 is curved and protrudes toward the information storage disk 140. The information storage disk 140 is tightly clamped between the pressure portion 151 and the flange portion 135c. The information storage disk 140 fitted around the hub 135 is deflected downward by gravity. Also, a pressure point P′1 of the pressure portion 151 is located further from the center than the supporting center P′2 of the flange portion 135c. If a relationship between the radius R′1 of the pressure point P′1 and the radius R′2 of a supporting center P′2 of the flange portion 135c is expressed by the following equation, then a direction of an applied rotational moment aggravates the flexing of the information storage disk.
R1′>R2′ [Equation]

Meanwhile, the flange portion 135c is provided with a U-shaped groove 135′. The U-shaped groove 135′ is inevitably formed while machining the sidewall portion 135b perpendicular to the flange portion 135c. The U-shaped groove 135′ is formed in the flange portion 135c, adjacent to a junction of the flange portion 135c and the sidewall portion 135c. However, since the U-shaped groove 135′ is formed in the flange portion 135c, a supporting area of the flange portion 135c is reduced and thus a supporting structure for the information storage disk 140 is weakened. This aggravates the flexing of the information storage disk.

### SUMMARY OF THE INVENTION

The present general inventive concept provides a spindle motor assembly usable in a hard disk drive, which can suppress flexing of a data storage disk.

The present general inventive concept further provides a spindle motor assembly usable in a hard disk drive, which can increase an effective data region of a data storage disk by reducing an ineffective disk area used to clamp the date storage disk.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a spindle motor assembly usable in a hard disk drive, the spindle motor assembly including at least one data storage disk, a spindle motor to drive the disk, the spindle motor having a hub to which the data storage disk is fixed, and a clamp member to fix the data storage disk to the hub by pressing the data storage disk axially toward the hub, wherein when the clamp member presses a first location of the data storage disk and the hub has a supporting center corresponding to a second location of the data storage disk, the first location is closer to a center of the data storage than the second location.

The clamp member may seat on the data storage disk fixed to the hub, and the spindle motor assembly may include a screw member to couple the clamp member to the hub. In addition, the clamp member may have a pressure portion to protrude toward the data storage disk to contact the first location.

The hub may have a supporting surface having an inner circumference with a radius Ri from a rotational axis thereof and an outer circumference with a radius Ro from the rotational axis, and the second location is located on a circumference having a mean radius ((Ri+Ro)/2) of the radii Ri and Ro.

The hub may have a sidewall portion around which the data storage disk is fitted and a flange portion on which the data storage disk seats, the flange portion extending from the sidewall portion in a radial direction of the data storage disk. The hub may have a groove formed in a portion of the sidewall portion which is adjacent to a junction between the sidewall portion and the flange portion.

The foregoing and/or other aspects of the present general inventive concept may also be achieved by providing a spindle motor assembly usable in a hard disk drive, the spindle motor assembly including at least one data storage disk, a spindle motor to rotate the data storage disk, the spindle motor having a hub about which the data storage disk rotates, the hub having a sidewall portion around which the data storage disk is fitted and a flange portion on which the data storage disk seats, the flange portion extending from the sidewall portion in a radial direction of the data storage disk, and a clamp member to fix the data storage disk to the hub by pressing the data storage disk axially toward the hub, wherein, when the clamp member presses a first location of the data storage disk and the hub has a supporting center corresponding to a second location of the data storage disk, the first location is closer to a center of the data storage than the second location, and the hub include a groove formed in a portion of the sidewall portion which is adjacent to a junction between the sidewall portion and the flange portion.

The foregoing and/or other aspects of the present general inventive concept may also be achieved by providing a spindle motor assembly usable in a hard disk drive, the spindle motor assembly including at least one data storage disk having a first surface, a second surface, and a third surface, a spindle motor having a hub to rotate the data storage disk, the hub having a sidewall portion to correspond to the first surface of the data storage disk and a flange portion to support the second surface of the data storage disk, the flange portion extending from the sidewall portion in a direction along one of the second and third surfaces of the data storage disk, and a clamp member to fix the data storage disk to the hub by pressing the third surface of the data storage disk toward the hub in a direction having an angle with the redial direction, wherein the hub comprises a groove formed on the sidewall portion, and the groove is not extended to the flange portion.

The foregoing and/or other aspects of the present general inventive concept may also be achieved by providing a hard disk drive, including a frame member having an inside space therein, and a spindle motor assembly disposed in the inside space of the frame, the spindle motor assembly having at least one data storage disk, a spindle motor to drive the disk, the spindle motor having a hub on which the data storage disk is fixed, and a clamp member to fix the data storage disk to the hub by pressing the data storage disk axially toward the hub, wherein, when the clamp member presses a first location of the data storage disk and the hub has a supporting center corresponding to a second location of the data storage disk, the first location is closer to the center of the data storage disk than the second location.

The foregoing and/or other aspects of the present general inventive concept may also be achieved by providing a hard disk drive, including a frame member having an inside space therein, and a spindle motor assembly disposed in the inside space of the frame, the spindle motor assembly having at least one data storage disk having a first surface, a second surface, and a third surface, a spindle motor having a hub to rotate the data storage disk, the hub having a sidewall portion to correspond to the first surface of the data storage disk and a flange portion to support the second surface of the data storage disk, the flange portion extending from the sidewall portion in a direction along one of the second and third surfaces of the data storage disk, and a clamp member to fix the data storage disk to the hub by pressing the third surface of the data storage disk toward the hub in a direction having an angle with the redial direction, wherein the hub comprises a groove formed on the sidewall portion, and the groove is not extended to the flange portion.

The foregoing and/or other aspects of the present general inventive concept may also be achieved by providing a spindle motor assembly usable in a hard disk drive, the spindle motor assembly at least one data storage disk having a first portion and a second portion extended from the first portion, a spindle motor having a hub to support the first portion of the at least one data storage disk, and a clamp member to clamp the at least one data storage disk to the hub of the spindle motor such that the spindle motor drives the disk to rotate together with the hub, the clamp member having a pressure portion to press the first portion of the data storage disk toward the hub, the pressure portion having a first distance from a rotation center of the data storage disk shorter than a second distance between the rotation center of the data storage disk and a center of the first portion of the at least one data storage disk.

The foregoing and/or other aspects of the present general inventive concept may also be achieved by providing a spindle motor assembly usable in a hard disk drive, the spindle motor assembly including at least one data storage disk, a spindle motor having a hub having a flange portion to support a portion of the at least one data storage disk, and a clamp member having a pressure portion disposed between a rotation center of the at least one data storage disk and a center of the portion of the at least one data storage disk to clamp the portion of the at least one data storage disk to the flange portion of the hub of the spindle motor such that the spindle motor drives the disk to rotate together with the hub.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view illustrating a conventional spindle motor assembly;

FIG. 2 is an exploded perspective view illustrating a hard disk drive to which is applied a spindle motor assembly according to an embodiment of the present general inventive concept;

FIG. 3 is a sectional view illustrating the hard disk drive of FIG. 2;

FIG. 4 is an enlarged sectional view illustrating a portion of the spindle motor of the spindle motor assembly of FIG. 2;

FIG. 5 is a graph comparing computer simulation results of deflection of a data storage disk according to the present embodiment in which a pressure point of a clamp member is closer to a center of the data storage disk than a supporting center, and according to a conventional spindle motor assembly in which the pressure point is away from the center of the data storage disk farther than the supporting center;

FIGS. 6A and 6B are computer simulation models used for computer simulation of the present embodiment and the conventional spindle motor assembly; and

FIG. 7 is a graph comparing computer simulation results of vertical deflection of a data storage disk according to the present embodiment in which a groove is formed on a sidewall portion of a hub, and according to a conventional spindle motor assembly in which a groove is formed on a flange portion of a hub.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

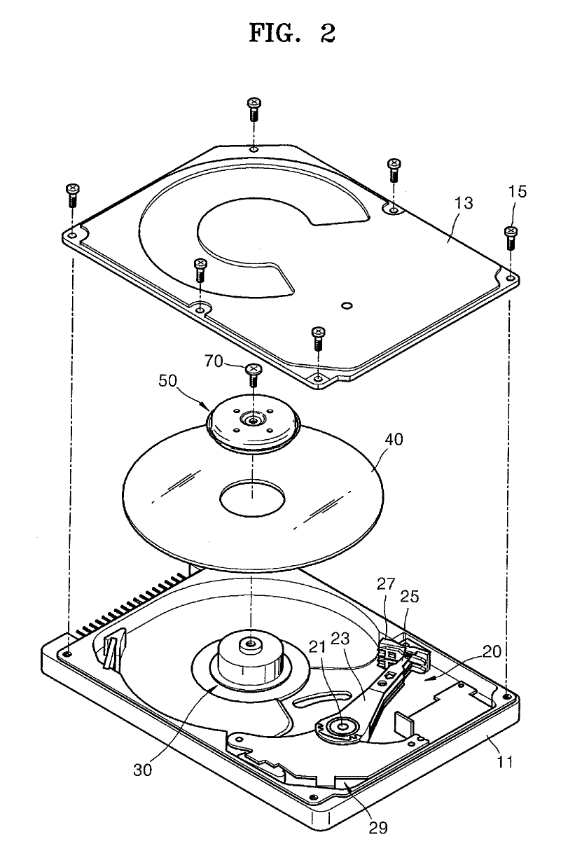

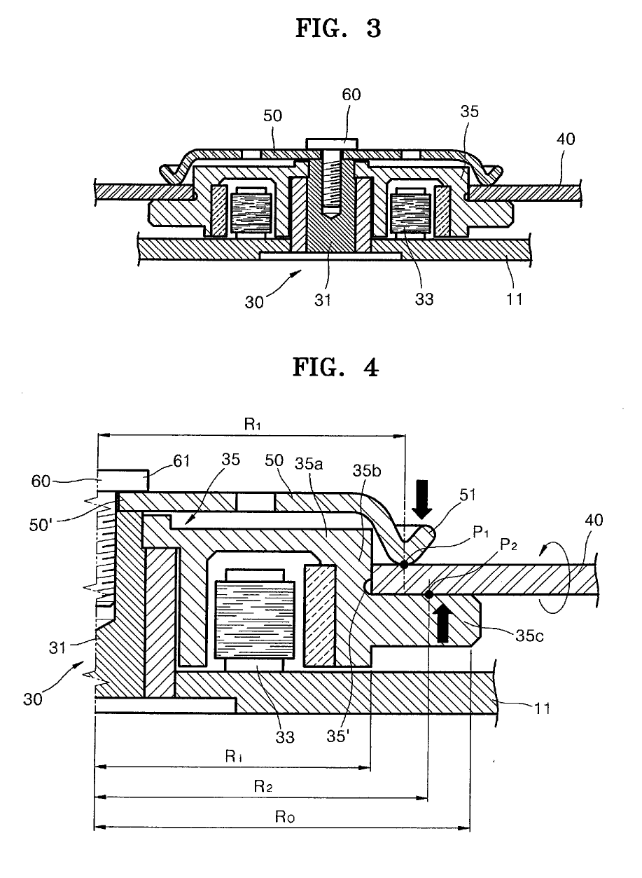

FIG. 2 is an exploded perspective view illustrating a hard disk drive to which is applied a spindle motor assembly according to an embodiment of the present general inventive concept, and FIG. 3 is a sectional view illustrating the hard disk drive of FIG. 2. Referring to FIGS. 2 and 3, an information storage device, such as a hard disk drive, includes a base frame 11, a cover member 13, a spindle motor assembly having a spindle motor 30, and at least one data storage disk (or information data storage) 40, and an actuator 20.

The base frame 11 may be formed of aluminum or aluminum alloy and may be formed by die-casting. A space to receive the spindle motor assembly and the actuator 20 is formed in the base frame 11. The space may be formed between the base frame 11 and the cover member 13.

The cover member 13 is fixed to a top portion of the base frame 11 by, for example, screws 15 to enclose and protect the data storage disk 40, the spindle motor 30, and the actuator 20, to exclude dust and moisture, and to prevent noise generated in the hard disk drive from passing out thereof.

The spindle motor assembly includes the spindle motor 30, the data storage disk 40, and a clamp member 50. The spindle motor 30 rotates the data storage disk 40, and includes a shaft 31 fixed to the base frame 11, a stator 33 fixed around the shaft 31, and a rotor, such as a hub 35, disposed to surround the stator 33. The data storage disk 40 includes one or more surfaces fitted around the hub 35.

The clamp member 50 is provided to securely fix the data storage disk 40 to the hub 35 of the spindle motor 30. The clamp member 50 is coupled to an upper end of the shaft 31 of the spindle motor 30 by a screw member 60 to press the data storage disk 40 downward.

The actuator 20 records data on the data storage disk 40 and reads the data stored on the data storage disk 40 by accessing a target track of the data storage disk 40 while pivoting in a clockwise or counterclockwise direction with respect to a pivot 21 above the rotating data storage disk 40. The actuator 20 includes a swing arm 23, a suspension 25, and a voice coil motor 29. The swing arm 23 is pivotally coupled to the pivot 21 installed on the base member 11. The suspension 25 is coupled to a tip of the swing arm 23 to bias a slider having a read/write head onto a surface of the data storage disk 40. The voice coil motor 29 provides a driving force to control the swing arm 23 to pivot with respect to the pivot 21. The voice coil motor 29 is controlled by a servo control system. The swing arm 32 pivots about the pivot 21 in a direction according to the Fleming's left-hand rule by an interaction between a current applied to a coil of a voice coil motor (VCM) and a magnetic field formed by a magnet thereof. That is, when the hard disk drive is switched on and the data storage disk 40 starts rotating, the swing arm 32 pivots in the counterclockwise direction around the pivot 21 by the voice coil motor 29 to position the read/write head above a recording surface of the data storage disk 40. When the hard disk drive is switched off and the data storage disk 40 stops rotating, the swing arm 23 pivots in the clockwise direction around the actuator pivot 21 to allow the read/write head to leave the recording surface of the data storage disk 40. After leaving the recording surface of the data storage disk 40, the read/write head rests on a ramp 27 disposed on a rest area of the data storage disk 40 or disposed on a position adjacent to the data storage disk 40.

FIG. 4 is an enlarged sectional view illustrating a portion of the spindle motor of FIG. 3. Referring to FIGS. 3 and 4, the hub 35 includes an upper end 35a, a sidewall portion 35b extending from the upper end 35a, and a flange portion 35c extending from the sidewall portion 35b in a radial direction of the spindle motor 30 or the data storage disk 40. The data storage disk 40 may have a first surface fitted around the sidewall portion 35b and a second surface placed on the flange portion 35c. The screw member 60 is coupled to the shaft 31 through a central hole of the upper end 35a. The screw member 60 has a screw head 61 which clamps a center of the clamp member 50. The clamp member 50 may be formed of an elastic material using a pressing method. The clamp member 50 has an opening 50′ at its center and a pressure portion 51 at its outer edge. The clamp member 50 may have a main portion extended along the upper end 35a of the hub 35, a first portion inclined downward from the main portion toward the data storage disk 40, a second portion inclined upward from the data storage disk 40, and a bent portion disposed between the first portion and the second portion. The opening 50′ is formed in the main portion, and the pressure portion 51 is formed on the bent portion of the clamp member 50. The pressure portion 51 is curved and protrudes toward the surface of the data storage disk 40. As the screw member 60 is tightened, the head 61 of the screw member 60 presses the clamp member 50 downward, and thus the pressure portion 51 presses against a third surface of the data storage disk 40 opposite to the second surface of the data storage disk 40 while being elastically deformed. The pressure portion 51 forms a pressure point P1 with the data storage disk 40 around a circumference having a first radius R1 from a center of the shaft 31, a center of the spindle motor 30, or a center of the data storage disk 40.

The data storage disk 40 is securely fixed between the flange portion 35c of the hub 35 and the clamp member 50 since the first, second, and third surfaces of the data storage disk 40 may tightly contact the sidewall portion 35b, the flange portion 35c, and the pressure portion 51, respectively. A top surface of the flange portion 35c constitutes a supporting plane that is evenly formed to contact the second surface of the data storage disk 40. The supporting plane is delimited (or defined) by an inner circumference having an inner radius Ri and an outer circumference having an outer radius Ro. The data storage disk 40 is securely clamped between the supporting plane of the flange portion 35 and the pressure portion 51 of the clamp member 50 to rotate together with the hub 35.

In the present embodiment, the pressure portion 51 of the clamp member 50, i.e., the pressure point P1 of the data storage disk 40, is closer to the center of the data storage disk 40 than a supporting center P2 of the flange portion 35c. The supporting center P2 represents a location to which an imaginary concentrated load can be equally applied when a predetermined distributed load applied from the supporting plane to the data storage disk 40 is equivalently transformed to the imaginary concentrated load. The supporting center P2 is located on a circumference having a second radius R2 that may be a mean ((Ri+Ro)/2) of the inner and outer radii Ri and Ro. Generally, a data storage disk that is locally clamped at its center is deflected further by gravity according to a distance from the center towards the outer edge thereof. However, since the pressure portion 51 or the pressure point P1 is closer to the center than the supporting center P2, a rotational moment may be generated in a direction from the second surface to a surface on which the third surface is disposed and may be applied in a direction opposite to a gravity direction to prevent the flexing of the data storage disk 40.

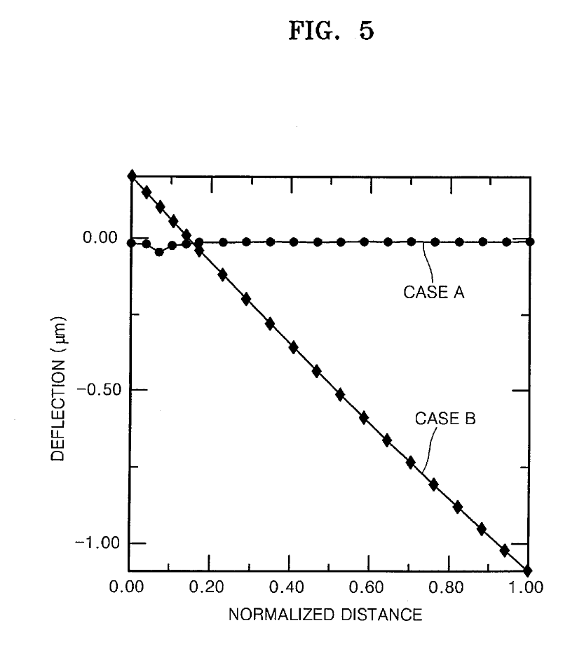

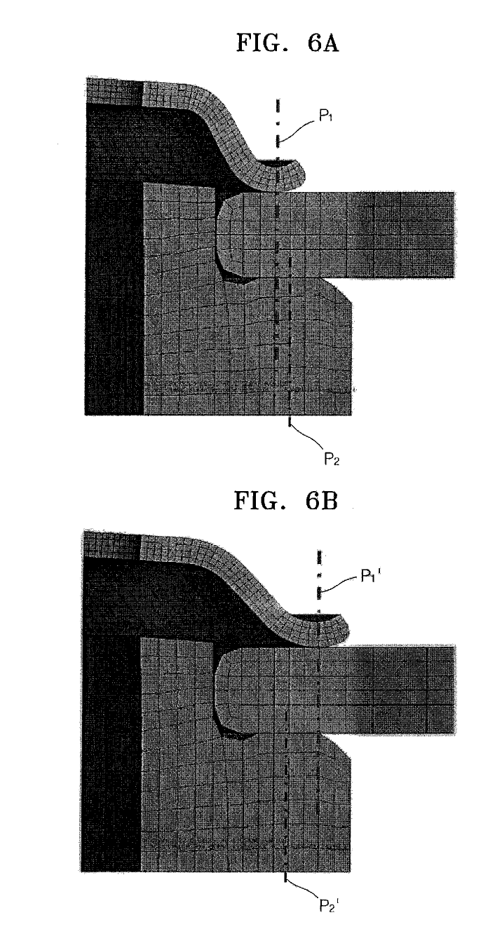

FIG. 5 is a graph of computer simulation results to illustrate an effect of the present general inventive concept, and FIGS. 6A and 6B are views illustrating computer simulation models used for computer simulation. Referring to FIGS. 2 through 6B, a case A where the pressure point P1 of the clamp member 50 is closer to the center of the data storage disk 40 than the supporting center P2 according to the present embodiment (see FIG. 6A) is compared with a case B where the pressure point P1′ is away from the center of the data storage disk 40 than the supporting center P2′ according to a conventional spindle motor assembly (see FIG. 6B). In the graph of FIG. 5, a horizontal axis denotes a normalized distance when an inner edge of the data storage disk 40 is set as a value of zero. A vertical axis denotes a measured amount of deflection. The measured amount of deflection may include a positive (+) value and a negative (−) value. The positive (+) value denotes that the data storage disk 40 is deflected above a reference line (or reference surface), and the negative (−) value denotes that the data storage disk 40 is deflected below the reference line (or reference surface). The reference line or surface represents a state of the data storage disk 40 before the screw member 60 is coupled to the hub 50 to apply the clamping force to the data storage disk 40.

In the case A, the deflection is small. A maximum deflection, which represents a degree of flexing of the data storage disk 40, is limited to a narrow range. In the case B, the deflection varies linearly in proportion to the normalized distance, and the maximum deflection is greater than that of the case A.

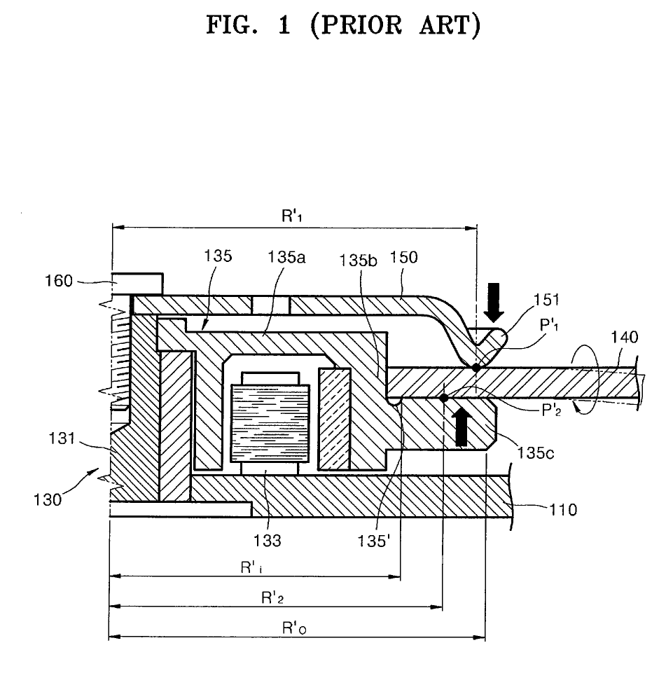

Referring back to FIG. 4, a circumferential groove 35′ is formed on a portion of the sidewall portion 35b adjacent to a junction of the sidewall portion 35b and the flange portion 35c, that is, a junction of the first and second surfaces of the data storage disk 40 so as to match the hub 35 with the data storage disk 40 being coupled to each other. In addition, the flange portion 35c has the supporting surface between the inner radius Ri and the outer radius Ro. In the present embodiment, since the groove 35′ is formed in the sidewall portion 35b, an area of the supporting surface can increase. That is, in a conventional spindle motor assembly of FIG. 1, since the groove 135′ is formed in the flange portion 135c, the area of the supporting surface is unnecessarily reduced. That is, there is a limitation in increasing the supporting surface.

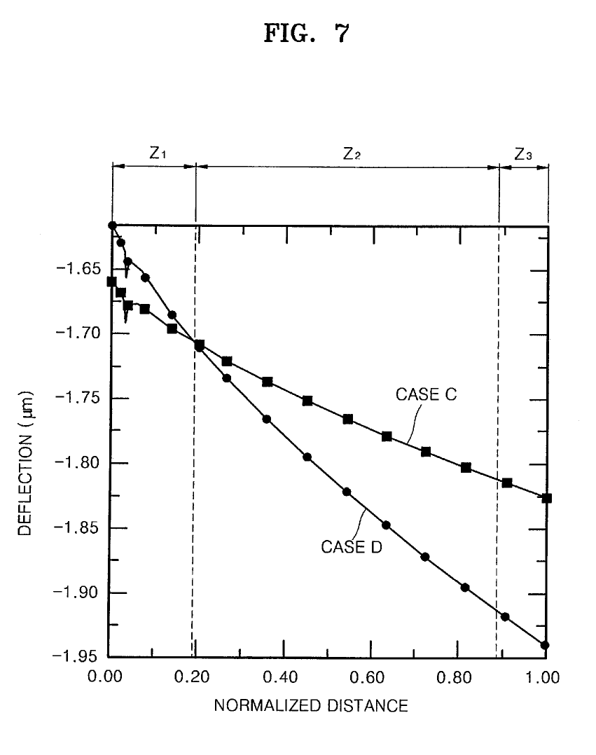

FIG. 7 is a graph illustrating computer simulation results of calculating a vertical deflection in a case C where the groove is formed on the sidewall portion according to the present general inventive concept and a case D where the groove is formed on the flange portion according to the conventional spindle motor assembly. Referring to FIGS. 2 through 7, a horizontal axis denotes a normalized distance in a radial direction when the inner edge of the data storage disk 40 is set as a value of zero. Reference signs Z1, Z2 and Z3 assigned along a radial line denote parking, data and ramp zones of the data storage disk 40. That is, the parking zone Z1 is formed at the inner edge, the ramp zone Z3 is formed at the outer edge, and the data zone Z2 is formed between the parking and ramp zones Z1 and Z3.

In the graph of FIG. 7, the normalized distance of the horizontal axis represents a measured amount of vertical deflection. The measured amount of vertical deflection may include a positive (+) value and a negative (−) value. The positive (+) value denotes a case when the data storage disk 40 is deflected above a reference line, and the negative (−) value denotes a case when the data storage disk 40 is deflected below the reference line. The reference line represents a state of the data storage disk 40 before the screw member 60 is coupled to the hub 35 to apply the clamping force to the data storage disk 40. For the flexing under gravity of the data storage disk 40, an absolute value of the vertical deflection of both cases C and D increases linearly in the radial direction of the data storage disk 40. The deflection in the case C (the present embodiment) is compared with the deflection in the case D (the conventional spindle motor assembly). In the parking zone Z1, the deflection in the case C is greater than that in the case D. In the data zone Z2, the deflection in the case C is smaller than that of the case D. Since the data zone Z2 is an effective region which actually functions as a data storage area of the data storage disk 40, the deflection of the data storage disk 40 in the data zone Z2 needs to be suppressed. A maximum deflection, which represents the flexing of the data zone Z2, is about 0.1 [symbol] in the case C while a maximum width of the deflection in the case D is about 0.2 [symbol] . This shows that the deflection in the present embodiment is reduced by 50% compared with the deflection in the conventional spindle motor assembly. This results from a fact that the supporting area for the data storage disk 40 increases by changing a location of the groove 35′.

In the present embodiment, a further effect can be realized in addition to the increase of the supporting area. That is, since the supporting surface is expanded inward, the pressure portion 51 of the clamp member can be moved further inward. Therefore, an ineffective disk region that is used for clamping can be reduced. Accordingly, an effective data zone is increased. As a result, a capacity of the hard disk drive 40 can increase. For example, the effective area of the data storage disk 40 can be increased by about 45% according to the present general inventive concept.

The spindle motor assembly of the present general inventive concept may further include two or more data storage disks. In this case, spacers may be interposed between the data storage disks to maintain gaps between the data storage disks.

According to the spindle motor assembly of the present embodiment, the flexing of the data storage disk can be suppressed by improving the clamping structure for the data storage disk. Furthermore, the data zone of the data storage disk can be maximized by reducing the ineffective disk area that is used for clamping.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A spindle motor assembly usable in a hard disk drive, comprising:
at least one data storage disk;
a spindle motor to drive the disk, the spindle motor having a hub on which the data storage disk is fixed; and
a clamp member to fix the data storage disk to the hub by pressing the data storage disk axially toward the hub,
wherein, when the clamp member presses a first location of the data storage disk and the hub has a supporting center corresponding to a second location of the data storage disk, the first location is closer to the center of the data storage disk than the second location.

2. The spindle motor assembly of claim 1, further comprising:
a coupling member to couple the clamp member to the hub,
wherein the clamp member seats on the data storage disk fixed on the hub and the data storage disk is fixed between the clamp member and the hub.

3. The spindle motor assembly of claim 1, wherein the clamp member comprises a pressure portion to protrude toward the data storage disk to contact the first location.

4. The spindle motor assembly of claim 1, wherein the hub comprises a supporting surface having an inner circumference with an inner radius from a rotational axis of the data storage disk and an outer circumference with an outer radius from the rotational axis, and the second location is located on a circumference having a mean radius of the inner and outer radii.

5. The spindle motor assembly of claim 1, wherein the hub comprises a sidewall portion around which the data storage disk is fitted and a flange portion by which the data storage disk is supported, and the flange portion extends from the sidewall portion in a radial direction of the data storage disk.

6. The spindle motor assembly of claim 5, wherein the hub comprises a groove formed on a portion of the sidewall portion which is adjacent to a junction between the sidewall portion and the flange portion.

7. A spindle motor assembly usable in a hard disk drive, comprising:
at least one data storage disk;
a spindle motor to rotate the data storage disk, the spindle motor having a hub about which the data storage disk rotates, the hub having a sidewall portion around which the data storage disk is fitted and a flange portion by which the data storage disk is supported, the flange portion extending from the sidewall portion in a radial direction of the data storage disk; and
a clamp member to fix the data storage disk to the hub by pressing the data storage disk toward the hub in a direction having an angle with the redial direction,
wherein, when the clamp member presses a first location of the data storage disk and the hub has a supporting center corresponding to a second location of the data storage disk, the first location is closer to the center of the data storage disk than the second location, and a groove is formed on a portion of the sidewall portion which is adjacent to a junction between the sidewall portion and the flange portion.

8. The spindle motor assembly of claim 7, further comprising:
a coupling member to couple the clamp member to the hub through the data storage disk,
wherein the clamp member seats on the data storage disk fixed to the hub, and the data storage is fixedly coupled between the hub and the clamp member.

9. The spindle motor assembly of claim 7, wherein the clamp member comprises a pressure portion to protrude toward the data storage disk to contact the first location.

10. The spindle motor assembly of claim 7, wherein the hub comprises a supporting surface having an inner circumference with an inner radius from a rotational axis of the data storage disk and an outer circumference with an outer radius from the rotational axis, and the second location is located on a circumference having a mean radius of the inner and outer radii.

11. A spindle motor assembly usable in a hard disk drive, comprising:
at least one data storage disk having a first surface, a second surface, and a third surface;
a spindle motor having a hub to rotate the data storage disk, the hub having a sidewall portion to correspond to the first surface of the data storage disk and a flange portion to support the second surface of the data storage disk, the flange portion extending from the sidewall portion in a direction along one of the second and third surfaces of the data storage disk; and
a clamp member to fix the data storage disk to the hub by pressing the third surface of the data storage disk toward the hub in a direction having an angle with the redial direction,
wherein the hub comprises a groove formed on the sidewall portion, and the groove is not extended to the flange portion.

12. A hard disk drive, comprising:
a frame member having an inside space therein; and
a spindle motor assembly disposed in the inside space of the frame, the spindle motor assembly comprising:
at least one data storage disk,
a spindle motor to drive the disk, the spindle motor having a hub on which the data storage disk is fixed, and
a clamp member to fix the data storage disk to the hub by pressing the data storage disk axially toward the hub,
wherein, when the clamp member presses a first location of the data storage disk and the hub has a supporting center corresponding to a second location of the data storage disk, the first location is closer to the center of the data storage disk than the second location.

13. A hard disk drive, comprising:
a frame member having an inside space therein; and
a spindle motor assembly disposed in the inside space of the frame, the spindle motor assembly comprising:
at least one data storage disk having a first surface, a second surface, and a third surface,
a spindle motor having a hub to rotate the data storage disk, the hub having a sidewall portion to correspond to the first surface of the data storage disk and a flange portion to support the second surface of the data storage disk, the flange portion extending from the sidewall portion in a direction along one of the second and third surfaces of the data storage disk, and
a clamp member to fix the data storage disk to the hub by pressing the third surface of the data storage disk toward the hub in a direction having an angle with the redial direction,
wherein the hub comprises a groove formed on the sidewall portion, and the groove is not extended to the flange portion.

14. A spindle motor assembly usable in a hard disk drive, comprising:
at least one data storage disk having a first portion and a second portion extended from the first portion;
a spindle motor having a hub to support the first portion of the at least one data storage disk; and
a clamp member to clamp the at least one data storage disk to the hub of the spindle motor such that the spindle motor drives the disk to rotate together with the hub, the clamp member having a pressure portion to press the first portion of the data storage disk toward the hub, the pressure portion having a first distance from a rotation center of the data storage disk shorter than a second distance between the rotation center of the data storage disk and a center of the first portion of the at least one data storage disk.

15. The spindle motor assembly of claim 14, wherein:
the hub comprises an upper end extended in a radial direction, a flange portion to support the first portion of the at least one data storage disk, and a sidewall portion disposed between the upper end and the flange portion; and
the clamp member comprises a main portion extended in the radial direction to correspond to the upper end of the hub, a first portion inclined toward the at least one data storage disk from a portion of the upper end before the sidewall portion, a second portion inclined with respect to the first portion, and a bent portion disposed between the first portion and the second portion and including the pressure portion.

16. The spindle motor assembly of claim 14, wherein:
the hub comprises an upper end extended in a radial direction, a flange portion to support the first portion of the at least one data storage disk, a sidewall portion disposed between the upper end and the flange portion, and a groove formed on the sidewall portion from a junction between the sidewall and the flange.

17. The spindle motor assembly of claim 16, wherein the groove is not formed on the flange portion.

18. The spindle motor assembly of claim 16, wherein:
the at least one data storage disk comprises a first surface to correspond to the sidewall portion, a second surface to be supported by the flange portion, and a third surface to contact the pressure portion; and
the groove does not face the second surface but faces the first surface of the at least one data storage disk.

19. The spindle motor assembly of claim 16, wherein the pressure portion is disposed between the groove and the center of the first portion of the at least one data storage disk.

20. The spindle motor assembly of claim 14, wherein:
the hub comprises an upper end, a flange portion to support the first portion of the at least one data storage disk, and a sidewall portion disposed between the upper end and the flange portion;
the at least one data storage disk comprises a first surface to correspond to the sidewall portion, a second surface to be supported by the flange portion, and a third surface to contact the pressure portion of the clamp member; and
the pressure portion is disposed between the sidewall portion and a center of the second surface of the at least one data storage disk.
